(19) United States
(12) Patent Application Publication
(10) Pub. No.: US 2021/0054568 A1
(43) Pub. Date: Feb. 25, 2021

(54) WATER AND OIL RESISTANT COMPOSITIONS

(71) Applicant: W-CYCLE HOLDINGS INT. LTD., Kibbutz Gan Shmuel (IL)

(72) Inventor: Joseph SIANI, Pardes-Hana (IL)

(21) Appl. No.: 16/957,914

(22) PCT Filed: Dec. 26, 2018
(86) PCT No.: PCT/IL2018/051394

§ 371 Date: Jun. 25, 2020

Related U.S. Application Data
(60) Provisional application No. 62/610,321, filed on Dec. 26, 2017.

(51) Int. Cl. D21H 21/16; C08F 220/24; D21H 17/37; D21H 11/14; D21H 27/10

(52) U.S. Cl. CPC D21H 21/16; C08F 220/24; D21H 27/10; D21H 11/14; D21H 17/37

(57) ABSTRACT

A composition made of pulp and two additives is disclosed herein. Further disclosed are articles (e.g., food or medicament receptacle containers) made of the disclosed composition.

### CROSS-REFERENCE TO RELATED APPLICATIONS

This application claims the benefit of priority of U.S. Provisional Patent Application No. 62/610,321 filed Dec. 26, 2017, the contents of which are incorporated herein by reference in their entirety.

### FIELD OF THE INVENTION

The present invention, in some embodiments thereof, relates to a composition comprising pulp, and uses thereof for e.g., in water, oil and heat resistant articles.

### BACKGROUND OF THE INVENTION

Modern society is on the go, and there is plenty of demand for a quick bite at all times of the day. Busy citizens demand quick meal options. There is a need for quick on-the-go (OTG) foods that can be heated e.g., in a microwave or turbochef.

It is also desirable to consume some food products at temperatures above room temperature. This is frequently the case when a food that has been cooked is being consumed. Ideally, a consumer wants to eat the food shortly after it has been prepared so it is still warm. The on-the-go food products are typically heated in a microwave, on a stove, inside a hot air oven, or other known heating methods, shortly before they are consumed. Similarly, many examples of commercially available refrigerated and frozen foods exist in the marketplace, which are also heated shortly before consumption.

On-the-go food products, such as pasta, noodles, rice, pizza, soups, sandwiches, tortilla chips, instant oatmeal, cereals, grits, and potato fries are typically sold to consumers in individual single serving or multiple serving packages from convenience stores or grocery stores. The food products are typically packaged in non-microwavable packages.

Therefore, the food products need to be transferred into a microwavable/heat-able container and then heated before consumption.

Currently, heating is accomplished by adding a separate susceptor or an added package container for heating. Some food packages provide a microwavable/heat-able container as a separate piece in the overall container.

### SUMMARY OF THE INVENTION

The present invention, in some embodiments thereof, is directed to a composition comprising pulp, which is water-, oil- and heat-resistant. The invention is further directed to a process for preparing the disclosed composition.

According to one aspect, there is provided a composition comprising: a first pulp; an acrylate or any derivative thereof a fluoropolymer or any derivative thereof and water, wherein the acrylate or any derivative thereof and the fluoropolymer or any derivative thereof are present in the composition in a ratio ranging from 0.5:2 (w/w) to 2:20 (w/w) per 100 gr dry pulp.

In some embodiments, water is present in the composition in an amount of 0.1-3% by weight, or at least 80% by weight.

In some embodiments, the first pulp comprises one or more fibers characterized by a median width of 17 to 23 μm.

In some embodiments, the first pulp comprises sugar cane bagasse or a straw pulp.

In some embodiments, the composition further comprises a second pulp.

In some embodiments, the second pulp is different from the first pulp and comprises a material selected from the group consisting of: a wood pulp, paper, recycled paper, paperboard, or any combination thereof.

In some embodiments, the first pulp and the second pulp are present at a weight ratio of 70:30 to 95:5, respectively. In some embodiments, the weight ratio of the first pulp and the second pulp is 85:15 to 95:5.

In some embodiments, the derivative of acrylate comprises n-alkyl acrylate.

In some embodiments, alkyl is butyl.

In some embodiments, the derivative of fluoropolymer is perfluoroalkyl acrylic copolymer.

In some embodiments, the sugar cane bagasse comprises at least 95% cellulose, by weight.

In some embodiments, the fluoropolymer is present in the composition in an amount of 0.015 to 0.075%, per 100 gr dry pulp.

In some embodiments, the acrylate is present in the composition in an amount of 0.1 to 0.5%, per 100 gr dry pulp.

In some embodiments, the composition is characterized by thermal decomposition temperature higher than 200° C.

In some embodiments, the composition is characterized by thermal decomposition temperature of 300° C. to 400° C.

In some embodiments, the composition has water absorption at 25° C. for 10 minutes of 0.2 grams per square meter (gsm) at most, when measured by Cobb test.

In some embodiments, the composition has oil absorption at 180° C. for 20 minutes of 30 gsm at most, when measured by Cobb test.

In some embodiments, the composition is degradable, compostable, or both.

In some embodiments, an article comprising the disclosed composition is provided.

In some embodiments, the article is a food or medicament receptacle.

In some embodiments, the article has a tensile strength of 15 MPa to 35 MPa.

In some embodiments, the article has an ultimate elongation of 1.5% to 5%.

In some embodiments, the article has a Young's modulus of 1,000 to 1,800 MPa.

In some embodiments, tensile strength, ultimate elongation, or Young's modulus of the article are substantially not affected by moisture, water, or oil deposited thereon.

According to another aspect, there is provided a process for conferring water or oil resistance to a composition, comprising mixing: a first pulp, an acrylate or any derivative thereof, a fluoropolymer or any derivative thereof, and water, wherein the acrylate or any derivative thereof and the fluoropolymer or any derivative thereof are mixed in the composition in a ratio ranging from 0.5:2 (w/w) to 2:20 (w/w) per 100 gr dry pulp, thereby conferring water or oil resistance to the composition.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

FIGS. 1A-1C are graphs presenting differential scanning calorimetry (DSC) spectra of a paper (FIG. 1A), a bowel (FIG. 1B), and the herein disclosed article (tray) (also referred to as: “hot tray” (FIG. 1C)).

FIGS. 2A-2F are graphs presenting Fourier-transform infrared spectroscopy (FTIR) spectra of: a sugar based paper (FIG. 2A), a bowl (FIG. 2B), and the disclosed tray (FIG. 2C); comparative spectra of a printer paper (upper graph), the sugar based paper (middle graph), and cellulose (lower graph) (FIG. 2D), comparative spectra of bowl (upper graph) the sugar based paper (middle graph), and cellulose (lower graph) (FIG. 2E); and comparative spectra of the disclosed trays (upper graph), the sugar based paper (middle graph), and cellulose (lower graph) (FIG. 2F).

FIG. 3 is a photographic image of the herein disclosed tray.

### DETAILED DESCRIPTION

In some embodiments, there is provided a composition comprising: a pulp, an acrylate or any derivative thereof, a fluoropolymer or any derivative thereof; and water.

### Pulp

As used herein, the term “pulp” refers to any fibrous cellulosic material formed from a plant material. In some embodiments, the material can be formed by any procedure known in the art such as chemical digestion processes (e.g., sulfite, kraft, soda or organosols processes), thermo-mechanical processes (e.g., steam explosion) and mechanical processes (e.g., grinding). In some embodiments, other cellulose pulp impurities may be removed in whole or in part by a process which includes but is not limited to an oxidation or other bleaching process.

In some embodiments, there is provided a composition comprising a pulp. In some embodiments, the composition comprises a single pulp. In some embodiments, the composition is characterized by including a single pulp source. In some embodiments, the composition comprises a first pulp and a second pulp. In some embodiments, a first pulp and a second pulp are pulps of different sources. In some embodiments, a first pulp and a second pulp are pulps of different particle size.

In some embodiments, the pulp is a dry pulp. As used herein, the term “dry pulp” encompasses a pulp before hydration. In some embodiments, a dry pulp encompasses a pulp after dehydration. In some embodiments, a dry pulp is a hydrated pulp undergoing dehydration. In some embodiments, the pulp is a hydrated pulp after partial or complete dehydration. As used herein, the term “partial” encompasses any value or range from 50 to 99%.

In some embodiments, the pulp is a softened pulp. In some embodiments, the term “softened pulp” refers to fibrous end-use pulp (for example, e.g., fluff pulp) that has some chemical agent (softener) added to soften the pulp, e.g., by reducing interfiber bonding. In some embodiments, the addition of the softener results in a soft pulp sheet. In some embodiments, the chemical agents (e.g., softeners) are added to fluff pulps during sheet forming which make the pulp sheet softer and easier to fluff or defiber.

In another embodiment, provided is a composition comprising: a first pulp, a second pulp, and at least two additives. In another embodiment, at least two additives comprise: acrylate, a derivative of acrylate, fluoropolymer, a derivative of fluoropolymer, or any combination thereof.

In some embodiments, the first pulp is selected from, without being limited thereto, straw pulp, sugar cane bagasse, or a combination thereof. In some embodiments, the first pulp is present in an amount of 50-70%, 60-75%, 55-80%, 70-85%, 60-90%, 80-95%, 90-99%, or 100% by weight. Each possibility represents a separate embodiment of the invention.

In one embodiment, the phrase “by weight” includes by weight of the total composition, by weight of the dry composition, or by weight of the wet or water comprising composition. In one embodiment, the phrase “a dry composition” comprises less than 0.5% water, less than 0.1% water, less than 0.05% water, or less than 0.01% water, by weight.

In some embodiments, the first pulp comprises sugar bagasse. In some embodiments, sugarcane bagasse comprises cellulose. In some embodiments, sugarcane bagasse comprises hemicellulose. In some embodiments, the hemicellulose comprises xylan. In some embodiments, sugarcane bagasse comprises lignin. In some embodiments, sugarcane bagasse comprises cellulose and xylan. In some embodiments, sugarcane bagasse comprises cellulose and lignin. In some embodiments, sugarcane bagasse comprises xylan and lignin. In some embodiments, sugarcane bagasse comprises cellulose, xylan, and lignin.

In some embodiments, sugarcane bagasse comprises cellulose in an amount of 30% to 99%, by weight. In some embodiments, sugarcane bagasse comprises cellulose in an amount of 60% to 95%, by weight. In some embodiments, sugarcane bagasse comprises cellulose in an amount of 45% to 70%, by weight. In some embodiments, sugarcane bagasse comprises cellulose in an amount of 30%, 35%, 40%, 45%, 50%, 55%, 60%, 65%, 70%, 75%, 80%, 85%, 90%, 95%, or 98%, by weight, including any value and range therebetween. Each possibility represents a separate embodiment of the invention.

In some embodiments, sugarcane bagasse comprises xylan in an amount of 20% to 40%, by weight. In some embodiments, sugarcane bagasse comprises xylan in an amount of 20% to 30%, by weight. In some embodiments, sugarcane bagasse comprises xylan in an amount of 25% to 30%, by weight. In some embodiments, sugarcane bagasse comprises xylan in an amount of 20%, 25%, 30%, 35%, or 40%, by weight, including any value and range therebetween. Each possibility represents a separate embodiment of the invention.

In some embodiments, sugarcane bagasse comprises lignin in an amount of 10% to 30%, by weight. In some embodiments, sugarcane bagasse comprises lignin in an amount of 10% to 25%, by weight. In some embodiments, sugarcane bagasse comprises lignin in an amount of 10% to 20%, by weight. In some embodiments, sugarcane bagasse comprises lignin in an amount of 10%, 11%, 12%, 13%, 14%, 15%, 16%, 17%, 18%, 19%, 20%, 21%, 22%, 23%, 24%, or 25%, by weight, including any value and range therebetween. Each possibility represents a separate embodiment of the invention.

In some embodiments, the first pulp (e.g., sugarcane bagasse) comprises one or more fibers. In some embodiments, the one or more fibers are characterized by a median length of 1 mm to 2 mm. In some embodiments, the one or more fibers are characterized by a median length of 1.2 mm to 1.8 mm. In some embodiments, the one or more fibers are characterized by a median length of 1.2 mm to 1.6 mm. In some embodiments, the one or more fibers are characterized by a median length of: 1 mm, 1.1 mm, 1.2 mm, 1.3 mm, 1.4 mm, 1.5 mm, 1.6 mm, 1.8 mm, or 2 mm, including any value and range therebetween. In some embodiments, the one or more fibers are characterized by a median width of 17 μm to 23 μm. In some embodiments, the one or more fibers are characterized by a median width of 18 μm to 22 μm. In some embodiments, the one or more fibers are characterized by a median width of 18 μm to 21 μm. In some embodiments, the one or more fibers are characterized by a median width of 19 μm to 21 μm. In some embodiments, the one or more fibers are characterized by a median width of: 17 μm, 18 μm, 19 μm, 20 μm, 21 μm, 22 μm, or 23 μm, including any value and range therebetween. Each possibility represents a separate embodiment of the invention.

In some embodiments, the one or more fibers are characterized by a density of 0.5 g·m⁻³ to 1.7 g·m⁻³, 0.7 g·m⁻³ to 1.7 g·m⁻³, or 0.7 g·m⁻³ to 1.6 g·m⁻³. Each possibility represent a separate embodiment of the invention. In some embodiments, the one or more fibers are characterized by a density of: 0.5 g·m⁻³, 0.6 g·m⁻³, 0.7 g·m⁻³, 0.8 g·m⁻³, 0.9 g·m⁻³, 1 g·m⁻³, 1.1 g·m⁻³, 1.2 g·m⁻³, 1.3 g·m⁻³, 1.4 g·m⁻³, 1.5 g·m⁻³, 1.6 g·m⁻³, or 1.7 g·m⁻³, including any value and range therebetween. Each possibility represents a separate embodiment of the invention.

In some embodiments, the one or more fibers are characterized by a tensile strength of 200 MPa to 350 MPa, 220 MPa to 340 MPa, 220 MPa to 330 MPa, 230 MPa to 320 MPa, or 240 MPa to 310 MPa. Each possibility represents a separate embodiment of the invention. In some embodiments, the one or more fibers are characterized by a tensile strength of 200 MPa, 210 MPa, 220 MPa, 230 MPa, 240 MPa, 250 MPa, 260 MPa, 270 MPa, 280 MPa, 290 MPa, 300 MPa, 310 MPa, 320 MPa, 330 MPa, 340 MPa, or 350 MPa, including any value and range therebetween. Each possibility represents a separate embodiment of the invention.

In some embodiments, the one or more fibers are characterized by elongation at break of 5% to 10%. In some embodiments, the one or more fibers are characterized by elongation at break of 5.5% to 9.5%. In some embodiments, the one or more fibers are characterized by elongation at break of 6% to 9%. In some embodiments, the one or more fibers are characterized by elongation at break of 6% to 8.5%. In some embodiments, the one or more fibers are characterized by elongation at break of 5%, 5.5%, 6%, 6.5%, 7%, 7.5%, 8%, 8.5%, 9%, 9.5%, or 10%, including any value and range therebetween. Each possibility represents a separate embodiment of the invention.

In some embodiments, the one or more fibers are characterized by a Young's modulus of 12 GPa to 22 GPa, 12 GPa to 20 GPa, 15 GPa to 20 GPa, or 15 GPa to 18 GPa. Each possibility represents a separate embodiment of the invention. In some embodiments, the one or more fibers are characterized by a Young's modulus of 12 GPa, 12.5 GPa, 13 GPa, 13.5 GPa, 14 GPa, 14.5 GPa, 15 GPa, 15.5 GPa, 16 GPa, 16.5 GPa, 17 GPa, 17.5 GPa, 18 GPa, 18.5 GPa, 19 GPa, 19.5 GPa, or 20 GPa, including any value and range therebetween. Each possibility represents a separate embodiment of the invention.

In some embodiments, the second pulp comprises, without limitation, a wood pulp. In another embodiment, the second pulp is selected from, without being limited thereto, paper, recycled paper, paperboard, or a combination thereof. In some embodiments, the second pulp is present in the composition at a concentration of 30%, 25% 20%, 15%, 10%, 5%, 1% by weight, or absent therefrom. In some embodiments, the second pulp is present in the composition in an amount of 1-8%, 5-10%, 9-20%, 15-25%, 20-28%, or 26-35%, by weight. Each possibility represents a separate embodiment of the invention.

In some embodiments, the term “wood pulp” as used herein refers to a cellulosic material obtained from wood produced e.g., according to a pulping process.

In some embodiments, cellulosic hydroxyl groups naturally present in the cellulosic material have not been chemically substituted or derivatized.

In some embodiments, the wood pulp comprises 10% to 70%, by weight, cellulose. In some embodiments, the wood pulp comprises 10%, 20%, 30%, 40%, 50%, 60%, or 70%, by weight, cellulose, including any value and range therebetween. Each possibility represents a separate embodiment of the invention.

In some embodiments, the wood pulp comprises 30% to 60%, by weight, cellulose. In some embodiments, the wood pulp comprises 40% to 50%, by weight, cellulose. In some embodiments, the wood pulp comprises 30%, 40%, 50%, or 60%, by weight, cellulose, including any value and range therebetween. Each possibility represents a separate embodiment of the invention.

In some embodiments, the wood pulp comprises lignin in an amount of 20% to 40%, by weight. In some embodiments, the wood pulp comprises lignin in an amount of 20% to 35%, by weight. In some embodiments, the wood pulp comprises lignin in an amount of 25% to 35%, by weight. In some embodiments, the wood pulp comprises lignin in an amount of 25% to 30%, by weight. In some embodiments, the wood pulp comprises lignin in an amount of 20%, 21%, 22%, 23%, 24%, 25%, 26%, 27%, 28%, 29%, 30%, 31%, 32%, 33%, 34%, or 35%, by weight, including any value and range therebetween. Each possibility represents a separate embodiment of the invention.

In some embodiments, the wood pulp comprises hemi-cellulose in an amount of 20% to 35%, by weight. In some embodiments, the wood pulp comprises hemi-cellulose in an amount of 20% to 30%, by weight. In some embodiments, the wood pulp comprises hemi-cellulose in an amount of 25% to 30%, by weight. In some embodiments, the wood pulp comprises hemi-cellulose in an amount of 20%, 21%, 22%, 23%, 24%, 25%, 26%, 27%, 28%, 29%, 30%, 31%, 32%, 33%, 34%, or 35%, by weight, including any value and range therebetween. Each possibility represents a separate embodiment of the invention.

In some embodiments, the wood pulp comprises less than 10%, water by weight. In some embodiments, the wood pulp comprises 0.1%, 1%, 2%, 3%, 4%, 5%, 6%, 7%, 8%, 9%, or 10%, water by weight, and any value and range therebetween. Each possibility represents a separate embodiment of the invention.

In some embodiments, the first pulp and the second pulp are present at a weight ratio of 70:30 to 95:5, respectively.

In some embodiments, the first pulp and the second pulp are present at a weight ratio of 80:20 to 95:5, respectively. In some embodiments, the first pulp and the second pulp are present at a weight ratio of 70:30, 75:25, 80:20, 85:15, 90:10, or 95:5, respectively, including any value and range therebetween. Each possibility represents a separate embodiment of the invention.

### Additives

In some embodiments, the composition comprises an additive. In some embodiments, an additive is a polymeric additive. In some embodiments, an additive is a binder. In some embodiments, an additive is a thickener. In some embodiments, an additive is a viscosity enhancing agent. In some embodiments, an additive is a sizing agent. In some embodiments, an additive is an oil proofing agent (i.e., rendering a composition comprising thereof as oil proof). In some embodiments, an additive is a water proofing agent (i.e., rendering a composition comprising thereof as water proof).

In some embodiments, the composition comprises at least two additives. In some embodiments, at least two additives comprise at least 3, at least 4, at least 5, or at least 7 additives, and any range and value therebetween. In some embodiments, at least two additives comprise 2-3, 2-4, 2-5,2-6, 2-7, 3-4, 3-5, 3-6, 3-7, 4-5, 4-6, 4-7, 5-6, 5-7, or 6-7 additives. Each possibility represents a separate embodiment of the invention.

In some embodiments, a binder, for example an acrylate, is present in the composition in an amount of 5%, 7.5%, 10%, 12.5%, 15%, or 20% per 100 gr dry pulp, including any value and range therebetween. Each possibility represents a separate embodiment of the invention. In some embodiments, the binder, for example an acrylate, is present in the composition in an amount of 5, 7, 10, 12, 15, 17, 20 g per 100 gr dry pulp, and any value and range therebetween. Each possibility represents a separate embodiment of the invention. In some embodiments, a binder comprises a carboxylate (e.g., carboxylic acid) component such as, polymethacrylate, or a polyester based material.

In some embodiments, a sizing agent is present in the composition in an amount of 0.5 to 15% by weight. In some embodiments, a sizing agent comprises a diol. Non-limiting example of a diol is 2-methylpentane-2,4-diol. In some embodiment, a sizing agent may further comprise an acetic acid.

As used herein, the term “oil” encompasses any nonpolar chemical substance that is a viscous liquid at ambient temperatures and is both lipophilic and hydrophobic.

As used herein, the term “oil proofing” refers to having one or more characteristics selected from: oil repelling, oil resisting (or resistance), having less than 5% by weight of oil absorbance capacity, having less than 1% by weight of oil absorbance capacity, having less than 0.5% by weight of oil absorbance capacity hydrophilic, having less than 0.1% by weight of oil absorbance capacity non-hydrophobic, and any equivalent thereof. In some embodiments, an oil-proofing agent mixed with or coating a substrate or an article comprising thereof, renders it oil-proof.

In some embodiments, the oil proofing agent comprises fluoropolymer. In some embodiments, the oil proofing agent comprises perfluor-olefin. In some embodiments, the oil proofing agent comprises hydroxyl silicon. In some embodiments, the oil proofing agent comprises polysiloxane. In some embodiments, the oil proofing agent comprises epoxyethane. In some embodiments, the oil proofing agent comprises diisocyanate.

In some embodiments, a fluoropolymer comprises a fluorocarbon-based polymer with multiple carbonfluorine bonds. In some embodiments, the fluoropolymer comprises of fluoroalkyl groups, including e.g., CF₂ and CF₃ moieties. In some embodiments, the fluoropolymer comprises perfluoroalkyl acrylic copolymer. In some embodiments, a derivative of a fluoropolymer is selected from: polyvinylfluorine, polyvinylidene fluorine, polytetrafluoroethylene, polychlorotrifluoroethylene, perfluoroalkoxy polymer, fluorinated ethylene-propylene, polyethylenetetrafluoroethylene, polyethylenechlorotrifluoroethylene, Perfluorinated Elastomer (Perfluoroelastomer), Fluorocarbon (Chlorotrifluoroethylenevinylidene fluoride), Fluoroelastomer (Tetrafluoroethylene-Propylene), Perfluoropolyether, Perfluoropolyoxetane, Perfluorosulfonic acid, or any combination thereof.

In some embodiments, the oil proofing agent, for example fluoropolymer, is present in the composition in an amount of 0.001% to 0.01%, per 100 gr dry pulp. In some embodiments, the fluoropolymer is present in the composition in an amount of 0.015% to 0.05%, per 100 gr dry pulp.

In some embodiments, the fluoropolymer is present in the composition in an amount of 0.015% to 0.075%, per 100 gr dry pulp. In some embodiments, the fluoropolymer is present in the composition in an amount of 0.02% to 0.095%, per 100 gr dry pulp. In some embodiments, the fluoropolymer is present in the composition in an amount of 0.025% to 0.15%, per 100 gr dry pulp. In some embodiments, the fluoropolymer is present in the composition in an amount of 0.1% to 5%, per 100 gr dry pulp. In some embodiments, the fluoropolymer is present in the composition in an amount of 0.5% to 3%, per 100 gr dry pulp. In some embodiments, the fluoropolymer is present in the composition in an amount of 1% to 2%, per 100 gr dry pulp. In some embodiments, the fluoropolymer is present in the composition in an amount of 0.1%, 0.5%, 1%, 1.5%, 2%, 2.5%, 3%, 3.5%, 4%, 4.5%, or 5%, per 100 gr dry pulp, including any value and range therebetween. Each possibility represents a separate embodiment of the invention. In some embodiments, the fluoropolymer is present in the composition in an amount of 0.001 g to 0.01 g, per 100 gr dry pulp. In some embodiments, the fluoropolymer is present in the composition in an amount of 0.015 g to 0.05 g, per 100 gr dry pulp. In some embodiments, the fluoropolymer is present in the composition in an amount of 0.015 g to 0.075 g, per 100 gr dry pulp. In some embodiments, the fluoropolymer is present in the composition in an amount of 0.02 g to 0.095 g, per 100 gr dry pulp. In some embodiments, the fluoropolymer is present in the composition in an amount of 0.1 to 5 g, per 100 gr dry pulp. In some embodiments, the fluoropolymer is present in the composition in an amount of 0.5 to 3 g, per 100 gr dry pulp. In some embodiments, the fluoropolymer is present in the composition in an amount of 1 to 2 g, per 100 gr dry pulp. In some embodiments, the fluoropolymer is present in the composition in an amount of 0.1 g, 0.5 g, 1 g, 1.5 g, 2 g, 2.5 g, 3 g, 3.5 g, 4 g, 4.5 g, or 5 g, per 100 gr dry pulp, including any value and range therebetween. Each possibility represents a separate embodiment of the invention.

As used herein, the term “water proofing” refers to having one or more characteristics selected from: water repelling, water resisting (or resistance), as having less than 0.1% by weight of water absorbance capacity, as having less than 0.5% by weight of water absorbance capacity, as having less than 0.05% by weight of water absorbance capacity, as having less than 0.01% by weight of water absorbance capacity, hydrophobic, non-hydrophilic, and any equivalent thereof. In some embodiments, a water-resistant agent mixed with or coating a substrate or an article comprising thereof, renders it a water-resistant.

In some embodiments, the water proofing agent comprises acrylate or derivatives thereof. In some embodiments, acrylate is n-alkyl acrylate. In some embodiments, a derivative of acrylate is: an acrylic ester, a methyl acrylate, an ethyl acrylate, or any combination thereof.

In some embodiments, the water proofing agent, for example an acrylate, is present in the composition in an amount of 0.1% to 0.2%, per 100 gr dry pulp. In some embodiments, the acrylate is present in the composition in an amount of 0.15% to 0.3%, per 100 gr dry pulp. In some embodiments, the acrylate is present in the composition in an amount of 0.2% to 0.4%, per 100 gr dry pulp. In some embodiments, the acrylate is present in the composition in an amount of 0.35% to 0.5%, per 100 gr dry pulp. In some embodiments, the acrylate is present in the composition in an amount of 0.45% to 0.75%, per 100 gr dry pulp. In some embodiments, the acrylate is present in the composition in an amount of 0.7% to 1.5%, per 100 gr dry pulp. In some embodiments, the acrylate is present in the composition in an amount of 1% to 7%, per 100 gr dry pulp. In some embodiments, the acrylate is present in the composition in an amount of 5% to 20%, per 100 gr dry pulp. In some embodiments, the acrylate is present in the composition in an amount of 6% to 18%, per 100 gr dry pulp. In some embodiments, the acrylate is present in the composition in an amount of 7% to 15%, per 100 gr dry pulp. In some embodiments, the acrylate is present in the composition in an amount of 8% to 12%, per 100 gr dry pulp. In some embodiments, the acrylate is present in the composition in an amount of 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, 15%, 15.5%, 16%, 16.5%, 17%, 17.5%, 18%, 18.5%, 19%, 19.5%, or 20%, per 100 gr dry pulp, including any value and range therebetween. Each possibility represents a separate embodiment of the invention. In some embodiments, the water proofing agent, for example an acrylate, is present in the composition in an amount of 0.1 g to 0.2 g, per 100 gr dry pulp. In some embodiments, the acrylate is present in the composition in an amount of 0.15 g to 0.3 g, per 100 gr dry pulp. In some embodiments, the acrylate is present in the composition in an amount of 0.2 g to 0.4 g, per 100 gr dry pulp. In some embodiments, the acrylate is present in the composition in an amount of 0.35 g to 0.5 g, per 100 gr dry pulp. In some embodiments, the acrylate is present in the composition in an amount of 0.45 g to 0.75 g, per 100 gr dry pulp. In some embodiments, the acrylate is present in the composition in an amount of 0.7 g to 1.5 g, per 100 gr dry pulp. In some embodiments, the acrylate is present in the composition in an amount of 1 g to 7 g, per 100 gr dry pulp. In some embodiments, the acrylate is present in the composition in an amount of 5 g to 20 g, per 100 gr dry pulp. In some embodiments, the acrylate is present in the composition in an amount of 6 g to 18 g, per 100 gr dry pulp. In some embodiments, the acrylate is present in the composition in an amount of 7 g to 15 g, per 100 gr dry pulp. In some embodiments, the acrylate is present in the composition in an amount of 8 g to 12 g, per 100 gr dry pulp. In some embodiments, the acrylate is present in the composition in an amount of 0.1 g, 0.2 g, 0.5 g, 0.75 g, 1 g, 2 g, 3 g, 5 g, 5.5 g, 6 g, 6.5 g, 7 g, 7.5 g, 8 g, 8.5 g, 9 g, 9.5 g, 10 g, 10.5 g, 11 g, 11.5 g, 12 g, 12.5 g, 13 g, 13.5 g, 14 g, 14.5 g, 15 g, 15.5 g, 16 g, 16.5 g, 17 g, 17.5 g, 18 g, 18.5 g, 19 g, 19.5 g, or 20 g, per 100 gr dry pulp, including any value and range therebetween. Each possibility represents a separate embodiment of the invention.

In some embodiments, the two additives (e.g., oil and water proofing agents) are present in the composition in a ratio ranging from 0.5:2 (w/w) to 2:20 (w/w), per 100 gr dry pulp. As used herein, a ratio ranging from 0.5:2 (w/w) to 2:20 (w/w) comprises 0.5:4 (w/w) to 2:10 (w/w), 0.5:10 (w/w) to 2:15 (w/w), 0.8:6 (w/w) to 2:18 (w/w), 1:4 (w/w) to 1:10 (w/w), 1.5:6 (w/w) to 1.5:15 (w/w), 1:4 (w/w) to 2:9 (w/w), or 0.5:3.5 (w/w) to 1.5:13 (w/w), per 100 gr dry pulp. Each possibility represents a separate embodiment of the invention.

As used herein, the term “alkyl” describes an aliphatic hydrocarbon including straight chain and branched chain groups. In some embodiments, the alkyl group has 1 to 10 carbon atoms, or 1-40 carbon atoms. Whenever a numerical range; e.g., “1-10”, is stated herein, it implies that the group, in this case the alkyl group, may contain 1 carbon atom, 2 carbon atoms, 3 carbon atoms, etc., up to and including 10 carbon atoms. The alkyl can be substituted or unsubstituted. When substituted, the substituent can be, for example, an alkyl, an alkenyl, an alkynyl, a cycloalkyl, an aryl, a heteroaryl, a halide, a hydroxyl and an alkoxy, as these terms are defined herein. When substituted with a halide, the alkyl is referred to as a haloalkyl. The term “alkyl”, as used herein, also encompasses saturated or unsaturated hydrocarbon, hence this term further encompasses alkenyl and alkynyl. In exemplary embodiment, the alkyl is butyl.

### Water

In some embodiments, the composition comprises water in an amount of 0.1-3% by weight. In some embodiments, the composition comprises at least 80% water by weight, at least 85% water by weight, at least 90% water by weight, and any value and range therebetween. Each possibility represents a separate embodiment of the invention. In some embodiments, the composition comprises water in an amount of 0.1-5%, 1-10%, 70-80%, 75-90%, 85-95%, or 90-98% by weight. Each possibility represents a separate embodiment of the invention.

### Compositions and Articles

In some embodiments, the disclosed composition is resistant to one or more oils selected from organic oil and mineral oil. The term “organic oil” encompasses any animal or vegetable oil. The term “mineral oil” encompasses petroleum, refined components thereof, equivalent thereof, or any combination thereof. In some embodiments, oil resistant composition or article as described herein is characterized as having less than 5% by weight of oil absorbance capacity. In some embodiments, oil resistant composition or article as described herein is characterized as having less than 1% by weight of oil absorbance capacity. In some embodiments, oil resistant composition or article as described herein is characterized as having less than 0.5% by weight of oil absorbance capacity. In some embodiments, oil resistant composition or article as described herein is characterized as having less than 0.1% by weight of oil absorbance capacity.

In some embodiments, the composition of the invention comprises a synthetically produced cellulose. Synthetic production of cellulose comprises the stripping of lignin from the pulp. As used herein, a synthetic cellulose is partially stripped from lignin. The term “partially” encompasses any value between 0.1 to 99%. In some embodiments, the composition comprises a chemically-produced cellulose. In some embodiments, the composition comprises biologically-produced cellulose. In some embodiments, the composition comprises thermomechanically produced cellulose.

In some embodiment, the composition disclosed herein is water resistant. In some embodiment, the composition is oil resistant. In some embodiment, the composition is water and oil resistant.

In some embodiments of the present invention, an article (e.g., an article-of-manufacturing) comprising a composition as disclosed herein is provided.

In some embodiments of the present invention, the article is in the form of a plate. In some embodiments of the present invention, the article is in the form of a tray, such as but not limited to a food tray. In some embodiments of the present invention, the article is in the form of a molded package. In some embodiments, the article is in the form of a container. In some embodiments, the article is the form of a receptacle. As used herein, the terms “receptacle” and “container” are interchangeable.

In some embodiments, at least portion of the article has a thickness of 0.5 mm, 1 mm, 2 mm, 5 mm, 7 mm, 8 mm, 9 mm, or 1 cm, including any value and range therebetween. Each possibility represents a separate embodiment of the invention. In some embodiments, at least portion of the article has a thickness of 0.5 mm to 1 mm, 0.7 mm to 2 mm, 1 mm to 4 mm, 3 mm to 6 mm, 5 mm to 7 mm, 6 mm to 8 mm, 7 mm to 9 mm, or 8 mm to 1 cm. each possibility represents a separate embodiment of the invention.

In some embodiments, the disclosed composition enables a free selection of the shape of the article. In some embodiments, a wall of the tray is straight vis-à-vis its bottom. In some embodiments, a wall of the tray is not straight vis-à-vis its bottom, but may have any arbitrary curved shape. In some embodiments, a rim is not parallel with the bottom of the tray, but is curved.

In some embodiments, the article has a capacity to contain, store, hold, stow, or any equivalent thereof, food stuff or an ingredient thereof, a medicament or an ingredient thereof, a herb, a fruit, a plant or any part thereof, and any combination thereof. In some embodiment, the article is used in containing food stuff or ingredients thereof. In some embodiments, the article is used in containing medicament or ingredients thereof. In some embodiments, the article is used in containing herbs, fruits, plants, or any plant part. The terms “contain”, “store”, “hold” and “stow” used herein, are interchangeable. In some embodiments, the article is fillable.

In some embodiments, the article is heat resistant. In some embodiments, the article is steam resistant. In some embodiments, the article is water-resistant. In some embodiments, the article is oil-resistant. In some embodiments, the article is steam- and water-resistant. In some embodiments, the article is steam- and oil-resistant. In some embodiments, the article is water- and oil-resistant. In some embodiments, the article is steam-, water- and oil-resistant. In some embodiments, the article is heat- and steam-resistant. In some embodiments, the article is heat- and water-resistant. In some embodiments, the article is heat- and oil-resistant. In some embodiments, the article is heat-, steam- and water-resistant. In some embodiments, the article is heat-, steam- and oil-resistant. In some embodiments, the article is heat-, water- and oil-resistant. In some embodiments, the article is heat-, steam-, water- and oil-resistant.

In some embodiments, the article is a microwavable. In some embodiments, the article is oven-able (e.g., capable of withstand and/or endure conventional oven heating, e.g. 200-400° C.). In some embodiments, the article is steam-able (e.g., capable of withstand and/or endure seaming). In some embodiments, the article is used in food or medicament packaging.

In some embodiments, the composition or an article comprising thereof are resistant to temperature ranging from 1-10° C., 5-20° C., 15-40° C., 30-90° C., 65-100° C., 80-140° C., 110-210° C., 150-250° C., 175-245° C., 220-310° C., 290-350° C., 300-375° C., or 350-400° C. Each possibility represents a separate embodiment of the invention.

In some embodiments, the composition or an article comprising thereof are resistant to heat of a temperature ranging from 40-60° C., 50-80° C., 70-100° C., 90-120° C., 110-160° C., 150-200° C., 175-300° C., or 275-400° C., for a period of at least 5 min, at least 15 min, at least 30 min, at least 1 hour, at least 3 hours, at least 6 hours, at least 12 hours, at least 24 hours, and any value and range therebetween. Each possibility represents a separate embodiment of the invention.

In some embodiments, the composition or an article comprising thereof are resistant to heat of a temperature of at least 40° C., at least 50° C., at least 75° C., at least 100° C., at least 150° C., at least 175° C., at least 225° C., at least 300° C., at least 325° C., at least 350° C., at least 400° C., and any value and range therebetween, for a period of 5-15 min, 10-30 min, 30 min-1 hour, 1-3 hours, 2-6 hours, 4-12 hours, 10-16 hours, or 12-24 hours. Each possibility represents a separate embodiment of the invention.

In some embodiments, the composition or an article comprising thereof are resistant to heat of a temperature ranging from 40-60° C., 50-80° C., 70-100° C., 90-120° C., 110-160° C., 150-200° C., 175-300° C., or 275-400° C., for a period of 5-15 min, 10-30 min, 30 min-1 hour, 1-3 hours, 2-6 hours, 4-12 hours, 10-16 hours, or 12-24 hours. Each possibility represents a separate embodiment of the invention.

In some embodiments, the composition or an article comprising thereof are resistant to heat of a temperature of at least 40° C., at least 50° C., at least 75° C., at least 100° C., at least 150° C., at least 175° C., at least 225° C., at least 300° C., at least 325° C., at least 350° C., at least 400° C., and any value and range therebetween, for a period of at least 5 min, at least 15 min, at least 30 min, at least 1 hour, at least 3 hours, at least 6 hours, at least 12 hours, at least 24 hours, and any value and range therebetween. Each possibility represents a separate embodiment of the invention.

In some embodiments, the article is used for holding a content in room temperature. In some embodiments, the article is used for holding a content in ambient temperature. In some embodiments, the article is used for holding a content in sub-zero temperature. As used herein, sub-zero encompasses any temperature below zero degrees Celsius. In some embodiments, the article is used for holding a content in a temperature ranging from 1-10° C., 5-20° C., 15-40° C., 30-90° C., 65-100° C., 80-140° C., 110-210° C., 150-250° C., 175-245° C., 220-310° C., 290-350° C., 300-375° C., or 350-400° C. Each possibility represents a separate embodiment of the invention.

In some embodiments, a composition or an article as disclosed herein is characterized by one or more defined mechanical properties. Non-limiting exemplary mechanical properties are selected from Young's modulus, tensile strength, fracture strain, yield point, toughness, stiffness, creep resistance, work-to-failure, stress, percentage of elongation, and ultimate elongation.

In some embodiments, a composition or an article as disclosed herein is characterized by tensile strength of 10 to 50 MPa. In some embodiments, a composition or an article as disclosed herein is characterized by tensile strength of 10 to 40 MPa. In some embodiments, a composition or an article as disclosed herein is characterized by tensile strength of 15 to 50 MPa. In some embodiments, a composition or an article as disclosed herein is characterized by tensile strength of 15 to 40 MPa. In some embodiments, a composition or an article as disclosed herein is characterized by tensile strength of 15 to 35 MPa. In some embodiments, a composition or an article as disclosed herein is characterized by tensile strength of 10 MPa, 15 MPa, 20 MPa, 25 MPa, 30 MPa, 35 MPa, 40 MPa, 45 MPa, or 50 MPa, including any value and range therebetween.

In some embodiments, the term “tensile strength” as used herein is the maximum amount of force as measured e.g., in Newton's that a material can bear without or prior to tearing, breaking, necking forming microcracks or fractures.

In some embodiments, the terms “tearing”, “breaking”, “necking”, “forming microcracks” or “fractures” refer to a permanent deformation. In some embodiments, the term “permanent deformation” does not include microcracks or fractures. In some embodiments, by “permanent deformation” it is meant to refer at least 0.1%, 0.2%, 0.3%, 0.4%, 0.5%, or 1% deformity compared to the original dimension or structure, including any value therebetween. Each possibility represents a separate embodiment of the invention.

In some embodiments, a composition or an article as disclosed herein is characterized by ultimate elongation of 0.5% to 15%. In some embodiments, a composition or an article as disclosed herein is characterized by ultimate elongation of 1% to 15%. In some embodiments, a composition or an article as disclosed herein is characterized by ultimate elongation of 1.5% to 10%. In some embodiments, a composition or an article as disclosed herein is characterized by ultimate elongation of 1.5% to 8%. In some embodiments, a composition or an article as disclosed herein is characterized by ultimate elongation of 1.5% to 5%. In some embodiments, a composition or an article as disclosed herein is characterized by ultimate elongation of 2% to 4.5%. In some embodiments, a composition or an article as disclosed herein is characterized by ultimate elongation of 0.5%, 1%, 1.5%, 2%, 2.5%, 3%, 3.5%, 4%, 5%, 5.5%, 6%, 6.5%, 7%, 7.5%, 8%, 8.5%, 9%, 9.5%, 10%, 10.5%, 11%, 11.5%, 12%, 12.5%, 13%, 13.5%, 14%, 14.5%, or 15%, including any value and range therebetween. Each possibility represents a separate embodiment of the invention.

In some embodiments, the term “ultimate elongation” refers to the strain at break determined as a percentage with respect to the original length.

In some embodiments, a composition or an article as disclosed herein is characterized by a defined elastic modulus. In some embodiments, the phrase “elastic modulus” refers to Young's modulus. In some embodiments, the phrase “elastic modulus” is determined by response of a material to application of tensile stress (e.g., according to procedures known in the art).

In some embodiments, a composition or an article as disclosed herein is characterized by Young's modulus of 800 to 2,500 MPa. In some embodiments, a composition or an article as disclosed herein is characterized by Young's modulus of 1000 to 2,500 MPa. In some embodiments, a composition or an article as disclosed herein is characterized by Young's modulus of 1,200 to 2,300 MPa. In some embodiments, a composition or an article as disclosed herein is characterized by Young's modulus of 1,200 to 2,300 MPa. In some embodiments, a composition or an article as disclosed herein is characterized by Young's modulus of 800 MPa, 900 MPa, 1,000 MPa, 1,200 MPa, 1,300 MPa, 1,400 MPa, 1,500 MPa, 1,600 MPa, 1,700 MPa, 1,800 MPa, 1,900 MPa, or 2,000 MPa, including any value and range therebetween. Each possibility represents a separate embodiment of the invention.

In some embodiments, one or more mechanical properties are substantially not affected by a liquid absorbed or deposited on a surface of a composition or an article as disclosed herein. The term “liquid”, used herein, refers to water, oil, moisture or any combination thereof.

As used herein, the term “substantially not affected” means that the mechanical property varies within less than ±20%, less than ±15%, than ±10%, less than ±5%, or less than ±1%.

In some embodiments, the composition or an article as disclosed herein is metal free. In some embodiments, by “free” it is meant less than 0.005%, by weight. In some embodiments, the term “metal free” comprises heavy metal free. In some embodiments, the composition is free of one or more metals selected from Barium (Ba), Cobalt (Co), Cuprum (Cu), Iron (Fe), Lithium (Li), Manganese (Mn), Zinc (Zn), Nickel (Ni), Aluminum (Al), Arsenic (As), Cadmium (Cd), Chromium (Cr), Mercury (Hg), Lead (Pb), Antimony (Sb), and Selenium (Se).

Methods for determining the presence and/amount of a heavy metal in a sample would be apparent to one of ordinary skill in the art. Any method complying with an international standard may apply, such as Regulation EU 10/2011, Directive 94/62/EC and CONGE, or any equivalent thereof.

In some embodiments, the composition is devoid of formaldehyde. As used herein, a composition devoid of a formaldehyde comprises formaldehyde in an amount of 0.01 ppm (parts per million) at most. In some embodiments, a composition devoid of formaldehyde comprises formaldehyde in an amount of 0.001 ppm at most. In some embodiments, a composition devoid of formaldehyde comprises formaldehyde in an amount of 0.0001-0.002 ppm, 0.001-0.007 ppm, 0.002-0.008 ppm, or 0.005-0.01 ppm. Each possibility represents a separate embodiment of the invention. In some embodiments, the formaldehyde migration rate from the disclosed composition is less than 1 mg/kg, as determined by Regulation EU 10/2011. In some embodiments, the formaldehyde migration rate from the disclosed composition is 0.1-1 mg/kg, as determined by Regulation EU 10/2011.

Methods for determining the presence and/amount of a formaldehyde in a sample would be apparent to one of ordinary skill in the art, such as complies with.

In some embodiments, the composition is devoid of pesticides. As used herein, a composition devoid of a pesticide comprises a pesticide in an amount of 0.01 ppm (parts per million) at most. In some embodiments, a composition devoid of a pesticide comprises a pesticide in an amount of 0.001 ppm at most. In some embodiments, a composition devoid of a pesticide comprises a pesticide in an amount of 0.0001-0.002 ppm, 0.001-0.007 ppm, 0.002-0.008 ppm, or 0.005-0.01 ppm. Each possibility represents a separate embodiment of the invention.

Methods for determining the amount of a pesticide in a composition would be apparent to one of ordinary skill in the art, non-limiting examples of which, include, gas chromatography-(GC) or liquid chromatography-(LC) mass spectrometry (MS).

In some embodiments, the composition is compostable. In some embodiments, the composition is degradable. In some embodiments, the composition is compostable and degradable.

In some embodiments, the term “degradable” comprises biodegradable.

As used herein, the term “compostable” generally means that (1) a material is capable of being processed in a composting facility for solid waste; (2) if so processed, the material will end up in the final compost; and, (3) if the compost is used in the soil the material will ultimately biodegrade in the soil. A compostable material should be fully biodegraded to carbon dioxide and water. Biodegradation, as used herein, is intended to describe materials that are biologically degraded in vivo. Biodegradation is a very slow process and may take several months or even years to complete. The length of time the compostable material takes to fully biodegrade is not important as long as the compostable material itself and the intermediary decomposition products are not toxic or otherwise harmful to the soil or the crops and the man-made materials do not accumulate in the soil.

Methods for determining compostability are common and would be apparent to one of ordinary skill in the art. As a non-limiting example, compostability can be determined according to European standard EN 13432 (09-2000).

In some embodiments, degradability, for example biodegradability, is determined by measuring the actual metabolic conversion of the compostable material into carbon dioxide. In one embodiment, this property is quantitatively measured using the standard test method, EN 14046 (which is also published as ISO 14855: biodegradability under controlled composting conditions). The acceptance level is 90%, which must be reached in less than 6 months.

In some embodiments, the composition is a disintegrating composition. As used herein, the term “disintegrability” refers to the fragmentation and loss of visibility in the final compost (absence of visual contamination). In one embodiment, disintegrability is measured with a composting test (EN 14045). For example, the test material is degraded together with organic waste for 3 months, after which the compost is sieved with a 2 mm sieve. The residues of test material with dimensions higher than 2 mm are considered as not having disintegrated. This fraction must be less than 10% of the initial mass.

In some embodiments, the composition is free of Bisphenol A.

In some embodiments, the composition is free of plastic.

In some embodiments, the composition is devoid of one or more aflatoxins. In some embodiments, aflatoxin is selected from the group comprising: Aflatoxin B1, Aflatoxin B2, Aflatoxin G1, and Aflatoxin G2. In some embodiments, a composition devoid of aflatoxin comprises 0.3, 0.2. 0.1, 0.05, 0.005 mg/kg composition at most. In some embodiments, a composition devoid of aflatoxin comprises 0.005-0.2 mg/kg, 0.01-0.05 mg/kg, 0.03-0.1 mg/kg, 0.07-0.2 mg/kg, or 0.15-0.3 mg/kg composition at most. Each possibility represents a separate embodiment of the invention. In some embodiments, the composition comprises undetected levels of aflatoxin.

Methods for determining the amount of aflatoxin in a composition would be apparent to one of ordinary skill in the art, non-limiting examples of which, may include, thin-layer chromatography (TLC), high-performance liquid chromatography (HPLC), mass spectroscopy, enzyme-linked immune-sorbent assay (ELISA), and electrochemical immunosensor.

In some embodiments, a composition disclosed herein is arranged uniformly in the article. In some embodiments, by “uniformly”, it is meant that a weight ratio of a first pulp and a second pulp varies within a less than ±20%. In some embodiments, by “uniformly”, it is meant that a weight ratio of a first pulp and a second pulp varies within a less than ±15%. In some embodiments, by “uniformly”, it is meant that a weight ratio of a first pulp and a second pulp varies within a less than ±10%. In some embodiments, by “uniformly”, it is meant that a weight ratio of a first pulp and a second pulp varies within a less than ±5%. In some embodiments, by “uniformly”, it is meant that a weight ratio of a first pulp and a second pulp varies within a less than ±1%. In some embodiments, by “uniformly”, it is meant that a weight ratio of a first pulp and a second pulp varies within a less than ±0.1%.

### General

The terms “comprises”, “comprising”, “includes”, “including”, “having” and their conjugates mean “including but not limited to”. The term “consisting of” means “including and limited to”. The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical art.

Additional objects, advantages, and novel features of the present invention will become apparent to one ordinarily skilled in the art upon examination of the following examples, which are not intended to be limiting. Additionally, each of the various embodiments and aspects of the present invention as delineated hereinabove and as claimed in the claims section below finds experimental support in the following examples.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

### EXAMPLES

Reference is now made to the following examples, which together with the above descriptions illustrate some embodiments of the invention in a non-limiting fashion.

### Example 1

### The Disclosed Tray:

In exemplary procedures, wood pulps and sugarcane bagasse, in a ratio of 1:9, respectively, were mixed. The mixture was inserted into a softening refiner, while adding water to the mixture. The overall concentration of the pulps in the water was 3%, by weight.

Next, two additives were added to the mixture: (1) perfluoroalkyl acrylic copolymerisate cationic in aqueous/organic solution—1.5%, by weight, of the dried content of the pulps, and (2) n-butyl acrylate (CAS no.: 141-32-2)-10%, by weight, of the dried content of the pulps. The additives were added as per the vendor's instruction.

### Analyzed Materials, and Methods

a. A sugar based paper (referred to as: “paper”);
b. Tray: a food tray with 3 compartments, comprising wood pulp (about 10%) and sugarcane (about 90%);
c. Bowl: an oblong bowl of a competitor;
d. Printer paper: a standard printer paper.

In exemplary procedures, the following analyses were performed:

Fourier-transform Infrared (FT-IR) measures the vibration in molecules. The peaks receives are proportional to the energy of the vibrations and are typical of specific functional groups in molecules. FTIR is correlated to a broad library of materials.
Differential Scanning calorimetry (DSC): in this method a heat flux of a sample is measured vs. a reference as a function of temperature. When a material melts, and boils, it changes its crystallinity, and then there is a release or influx of heat. This heat can be quantified. In polymers specifically, it is useful to determine Tₘ and T_{g} which are reliable indicators of polymeric compositions with the molecular weight being correlated with the physical data.
Loss on Drying (LOD): the device comprises a scale with a heater and is used to calculate mainly water content in samples which are too heterogeneous for thermal gravimetric analysis. Samples are usually in the order of 0.5 g.

The devices were as follows:

FT-IR: Thermo Scientific Nicolet iS5 with a ID5 ATR adaptor;
DSC: Perkin Elmer DSC 6000 using pyris software;
LOD: mettler toledo HB43.
Thermal Gravimetric Analysis (TGA) did not show sufficient stability for the device. The data
were therefore achieved through other methods:
Differential Scanning calorimetry (DSC) was used to determine enthalpies, melting point (Tₘ) and decomposition point, T(dec), along with residual materials;
Loss on Drying (LOD) test was used to determine water content;
Fourier-transform Infrared (FT-IR) spectroscopy was used to analyze the composition.
The density was determined by the volume displacement of the materials.

### Results

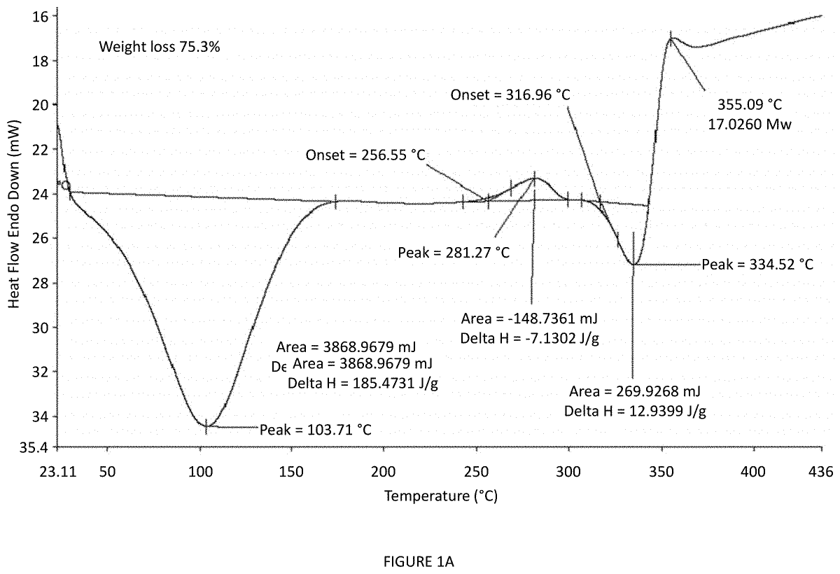

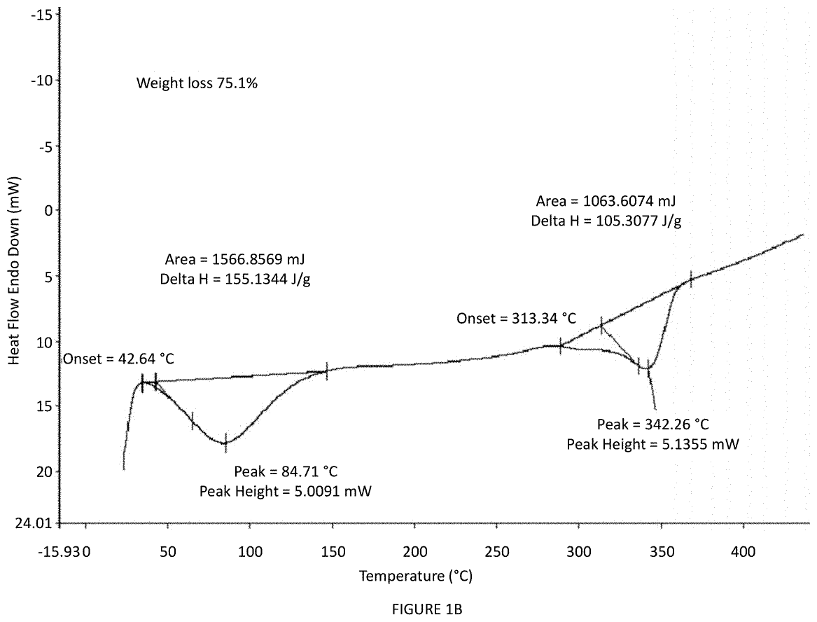

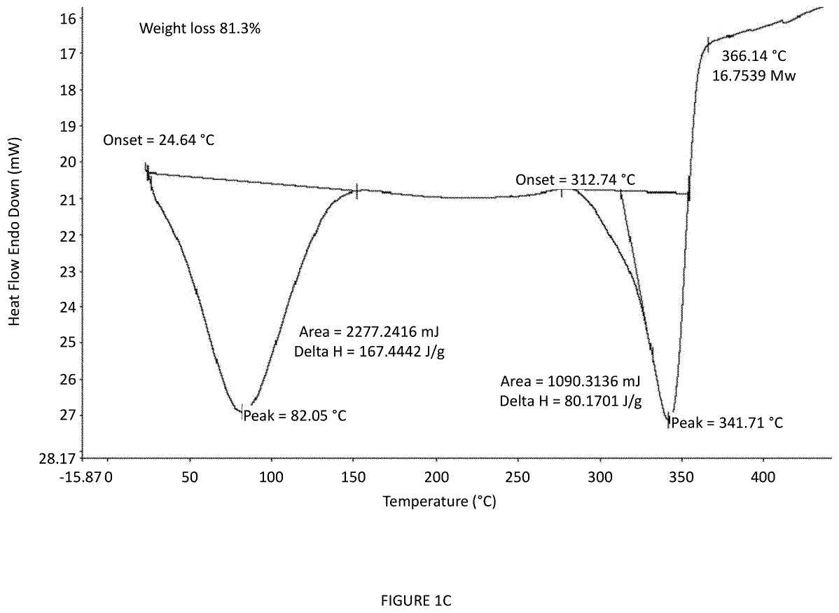

The DSC spectra are shown in FIGS. 1A-1C.

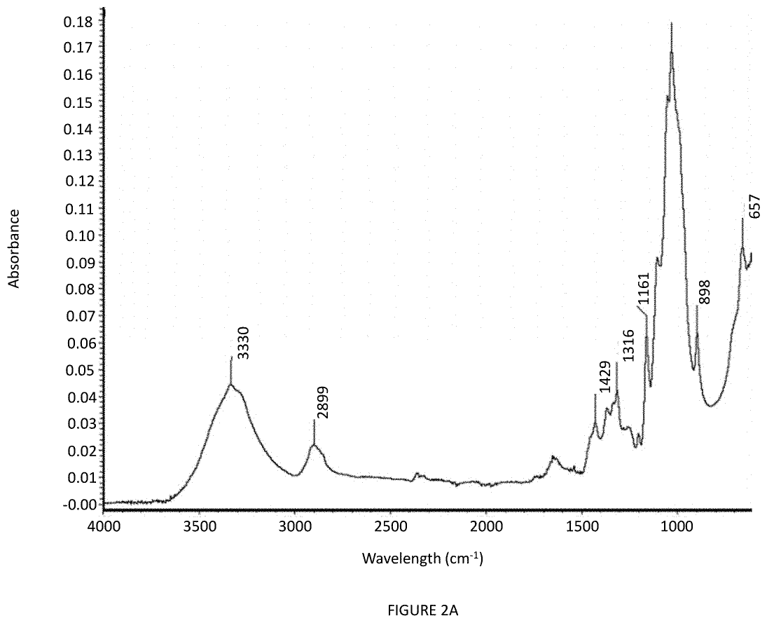

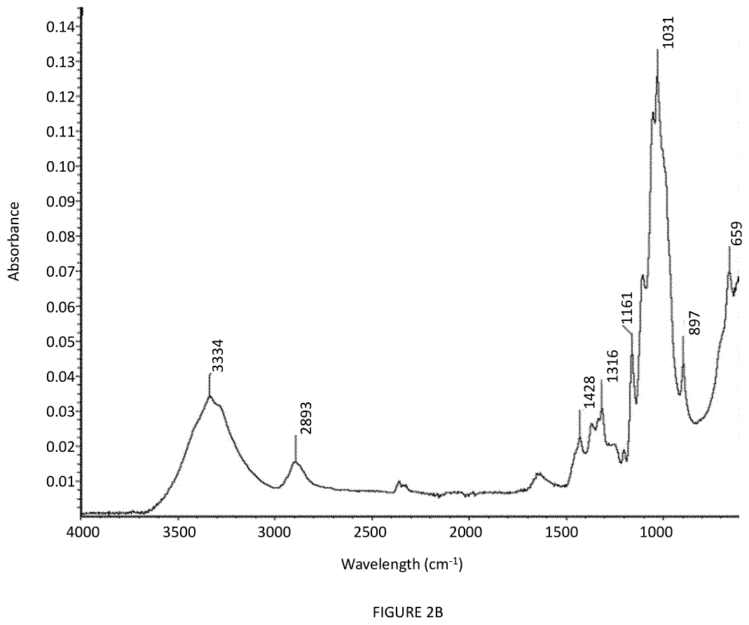

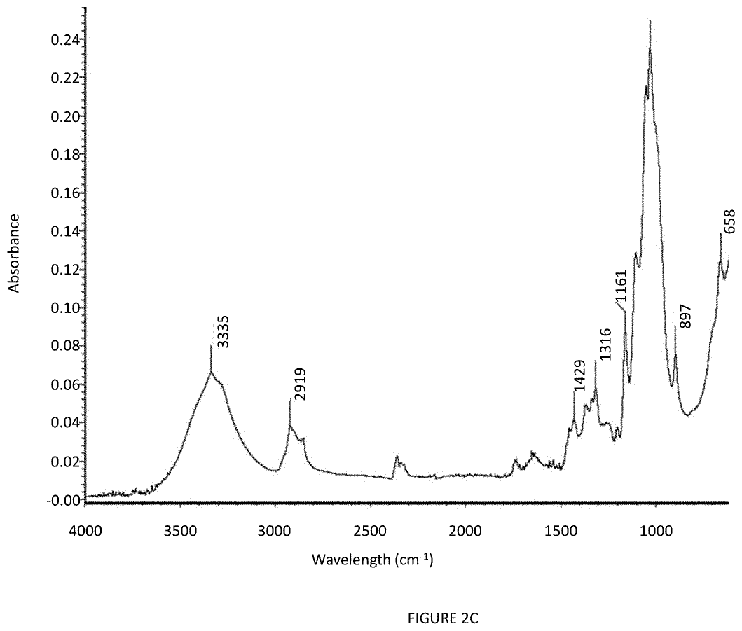

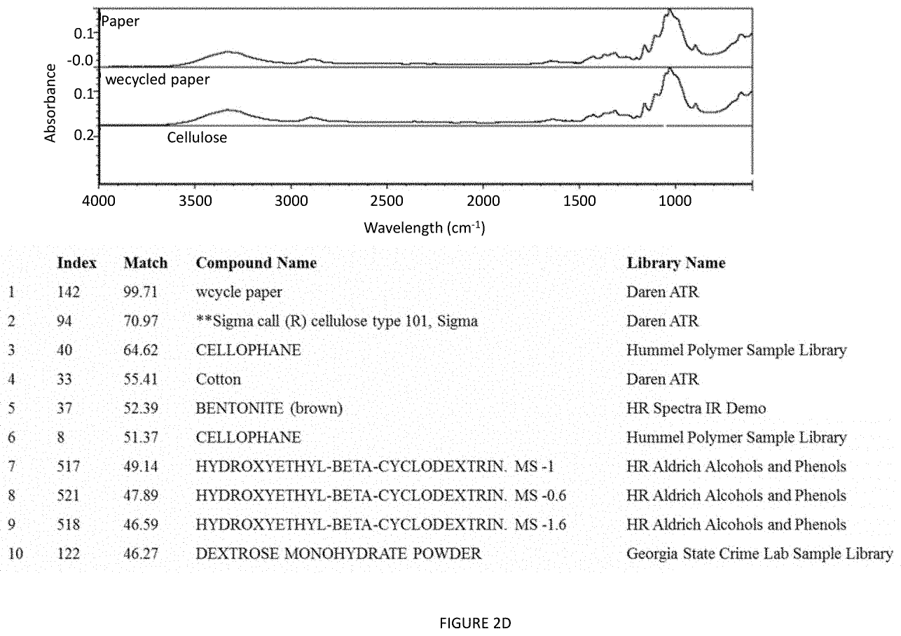

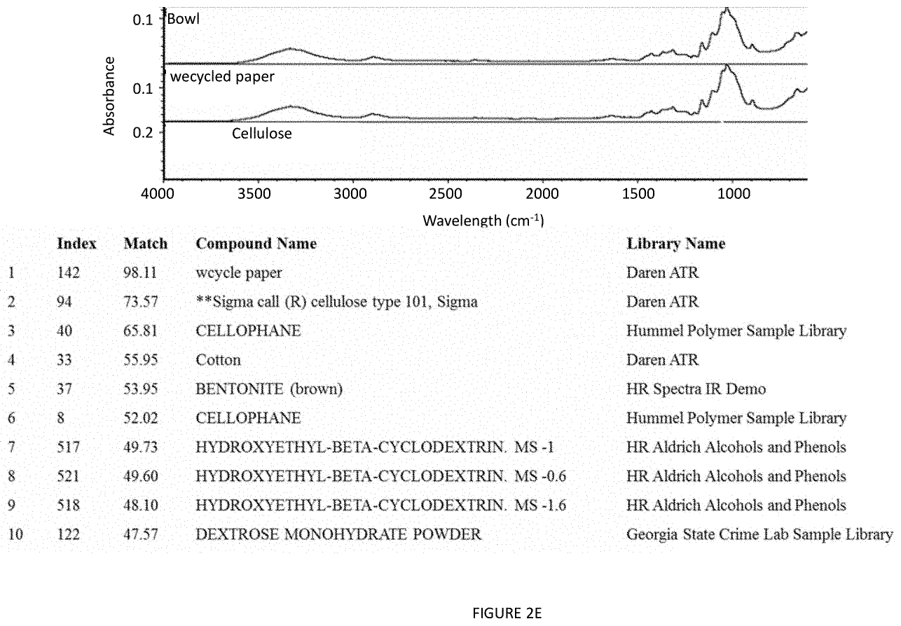

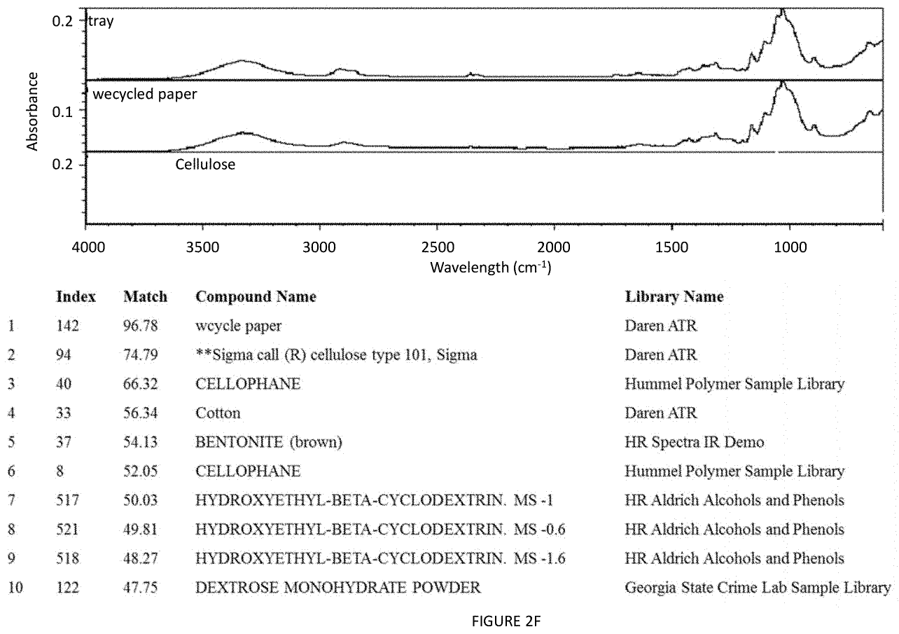

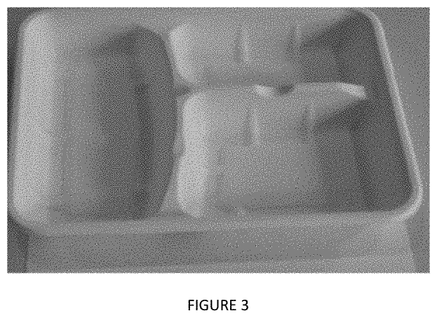

The FTIR spectra are shown in FIGS. 2A-2E.

The densities are as follows:
d(paper)=0.95 g/ml
d(tray)=0.94 g/ml
d(bowl)=0.93 g/ml
d(printer paper)=1.21 g/ml

LOD (remained weight after drying) is as follows:
Paper=93.54%, 93.51%
Tray=93.86%, 93.80%
Bowl=93.03%, 93.30%
Printer paper=94.17%, 94.22%

From the data developed, it is abundantly clear that the article of interest, the tray, is not a simply linear mixture as it clearly contains additional polymer binder. There may be an additional different binder. The additional polymer contains a significant carboxylic acid component and therefore it can likely be polymethacrylate or possibly polyester based. This finding is shown in several methodologies, by the much smaller T(dec) peak (the peak at 340° C.) and lower residual in the DSC, by the lower water content and by the peaks at below 3000 and at 1700 cm⁻¹ in the IR. This would explain the lower water and oil observations in the disclosed tray vs. the other products. DSC and IR allow to easily differentiate between the disclosed tray and reference bowl.

Although the difference in polymer content is difficult to quantify exactly, a reasonable estimate based on the DSC would be 36% more binder in the disclosed tray.

In further exemplary procedures the trays were heated to 270° C. for 1.5 min and were found stable (not being decomposed). In further exemplary procedures the trays were heated to 220° C. for 20 min and were found stable (not being decomposed).

### Example 2

### Mechanical Properties

In exemplary procedures, tests were performed on the disclosed trays and on cardboard plates (control) for tensile tests.

The tensile tests were performed according to the ASTM D 638 standard (Speed: 50 mm/min; Load-cell: 0.5 kN).

The results are summarized in Table 1 below.

TABLE 1

| | Tensile | Maximum | Elasticity |
|---|---|---|---|
| | Strength | Elongation | Module |
| Product | (MPa) | (%) | (MPa) |
| Plate | 19.1 | 1.9 | 1,537 |
| Tray | 24.3 | 4.5 | 1,311 |

### Example 3

The inventors wanted to examine different pulp raw materials reaction and visibility in hand sheets supplemented with various additives and to further determine quality assurance (QA) protocols. The hand sheet papers produced are specified hereinbelow (table 2).

TABLE 2
formulations of hand sheets

| | Additive | | | | | | | |
|---|---|---|---|---|---|---|---|---|
| | | | | | | | | Cationic |
| | | | | | | | | 10% + |
| | | | | | Fluoro- | Fluoro- | Fluoro- | Fluoro- |
| | | Cationic | Cationic | Cationic | polymer | polymer | polymer | polymer |
| Pulp | Blank | 5% | 10% | 20% | 0.7% | 1.5% | 0.35% | 1.5% |
| Recycled | n = 4 | n = 3 | n = 3 | n = 1 | n = 3 | n = 3 | — | n = 1 |
| Paper | | | | | | | | |
| BTMCP | n = 3 | n = 3 | n = 3 | — | n = 3 | n = 3 | n = 3 | n = 1 |
| Unbleached | n = 3 | n = 3 | n = 3 | — | n = 3 | n = 3 | — | n = 1 |
| sugarcane | | | | | | | | |
| Bleached | n = 3 | n = 3 | n = 3 | | — | — | | — |
| pulp | | | | | | | | |

The hand sheets (specified in table 2) were tested in a Cobb test, results of which are summarized in table 3.

TABLE 3
Cobb test results

| | | | | 25° C. | 25° C. |
|---|---|---|---|---|---|
| | | | | Water | Oil |
| | | Fluoro- | | Cobb | Cobb |
| Pulp | Cationic | polymer | MFC | gsm | gsm |
| Bleached | 0 | 0 | 0 | 1.10 | 0.86 |
| Bagasse | | | | | |
| Bleached | 0 | 0 | 5 | 1.14 | 0.94 |
| Bagasse | | | | | |
| Bleached | 5 | 0 | 0 | 0.04 | 0.68 |
| Bagasse | | | | | |
| Bleached | 10 | 0 | 0 | 0.06 | 0.65 |
| Bagasse | | | | | |
| recycled paper | 0 | 0 | 0 | 0.59 | 0.69 |
| USA - Verso | | | | | |
| recycled paper | 5 | 0 | 0 | 0.06 | 0.51 |
| USA - Verso | | | | | |
| recycled paper | 10 | 0 | 0 | 0.05 | 0.72 |
| USA - Verso | | | | | |
| recycled paper | 20 | 0 | 0 | 0.03 | 0.91 |
| USA - Verso | | | | | |
| recycled paper | 0 | 0.7 | 0 | 0.05 | 0.07 |
| USA - Verso | | | | | |
| recycled paper | 0 | 1.5 | 0 | 0.05 | 0.05 |
| USA - Verso | | | | | |
| recycled paper | 10 | 1.5 | 0 | 0.06 | 0.09 |
| USA - Verso | | | | | |
| Unbleached | 0 | 0 | 0 | 0.57 | 0.67 |
| Bagasse | | | | | |
| Unbleached | 5 | 0 | 0 | 0.04 | 0.79 |
| Bagasse | | | | | |
| Unbleached | 10 | 0 | 0 | 0.06 | 0.63 |
| Bagasse | | | | | |
| Unbleached | 0 | 0.7 | 0 | 0.06 | 0.06 |
| Bagasse | | | | | |
| Unbleached | 0 | 1.5 | 0 | 0.03 | 0.05 |
| Bagasse | | | | | |
| Unbleached | 10 | 1.5 | 0 | 0.06 | 0.05 |
| Bagasse | | | | | |
| BCTMP | 0 | 0 | 0 | 0.55 | 0.77 |
| BCTMP | 5 | 0 | 0 | 0.06 | 0.91 |
| BCTMP | 10 | 0 | 0 | 0.05 | 1.09 |
| BCTMP | 0 | 0.35 | 0 | 0.23 | 0.20 |
| BCTMP | 0 | 0.7 | 0 | 0.53 | 0.23 |
| BCTMP | 0 | 1.5 | 0 | 0.14 | 0.14 |
| BCTMP | 10 | 1.5 | 0 | 0.02 | 0.18 |
| Spray | 1 | 1.5 | 0 | 0.17 | 0.38 |
| coating | | | | | |

### Example 4

For testing the hotray, tomato, oil, or chicken were placed on the tray, which was then sealed with a top leading film. Then, the hotray was placed in an oven for 30 min at 180° C. Thereafter, the hotray was visually inspected as follows: opposite of a strong light source, the hotray was carefully inspected for any visible observation. In case such observation was made, the hotray was considered not good. When no observation was made, a following examination was conducted, as follows: the hotray was placed in a steamer for 2 hours, (halfway on the level of steaming). Then, the hotray was removed and inspected using light as described above, observing for any indication of oil absorbing and/or penetrating the hotray. The test was concluded as a success as there was no indication that the hotray absorbed oil.

### Example 5

The inventors then compared different commercially available paper products to the Hotray (an embodiment of the disclosed invention) according to a Cobb test. The test included, drying the sampled papers in an oven for 3 minutes, after which the samples were weighed, and weights were documented. Thereafter, samples were inserted to the Cobb device and 40 ml of cooking oil were deposited on each sample. The Cobb device and samples were transferred to an oven and heated at 180° C. for 20 minutes. After heating, excess oil was wiped from the paper samples, which were then weighed. The absorption percent was calculated as follows: (W_{f}−W₀)/W₀; wherein W₀ is weight at time 0 (e.g., before oil deposition), and wherein W_{f} is the final weight (e.g., after oil deposition and following heating).

TABLE 4
Cobb test results

| | Initial weight | Final weight | Oil absorption |
|---|---|---|---|
| Product | (W₀) | (W_{f}) | (%) |
| Hotray | 11.53 | 11.71 | 1.49 |
| Plain paper | 4.63 | 5.66 | 22.14 |
| Unbleached | 1.83 | 2.23 | 22.24 |
| Bagasse | | | |
| Bagasse | 1.56 | 1.76 | 12.74 |
| plate | | | |

Using this method the inventors showed the Hotray product absorbs substantially less oil than other commercially available paper products, specifically, under cooking simulating conditions (i.e., 180° C. for 20 minutes).

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

While certain features of the invention have been described herein, many modifications, substitutions, changes, and equivalents will now occur to those of ordinary skill in the art. It is, therefore, to be understood that the appended claims are intended to cover all such modifications and changes as fall within the true spirit of the invention.

1. A composition comprising:
(i) a first pulp;
(ii) an acrylate or any derivative thereof;
(iii) a fluoropolymer or any derivative thereof; and
(iv) water,
wherein said acrylate or any derivative thereof and said fluoropolymer or any derivative thereof are present in said composition in a ratio ranging from 0.5:2 (w/w) to 2:20 (w/w) per 100 gr dry pulp.

2. The composition of claim 1, wherein said water is present in said composition in an amount of 0.1-3% by weight, or at least 80% by weight.

3. The composition of claim 1, wherein said first pulp comprises one or more fibers characterized by a median width of 17 to 23 μm.

4. The composition of claim 1, further comprising a second pulp said second pulp is different from said first pulp and comprises a material selected from the group consisting of: a wood pulp, paper, recycled paper, paperboard, or any combination thereof.

5. (canceled)

6. (canceled)

7. The composition of claim 4, wherein said first pulp and said second pulp are present at a weight ratio of 70:30 to 95:5, respectively.

8. (canceled)

9. (canceled)

10. (canceled)

11. The composition of claim 1, wherein said derivative of said fluoropolymer is perfluoroalkyl acrylic copolymer.

12. (canceled)

13. The composition of claim 1, wherein said fluoropolymer is present in said composition in an amount of 0.015 to 0.075%, per 100 gr dry pulp.

14. The composition of claim 1, wherein said acrylate is present in said composition in an amount of 0.1 to 0.5%, per 100 gr dry pulp.

15. The composition of claim 1, characterized by thermal decomposition temperature higher than 200° C.

16. (canceled)

17. The composition of claim 1, wherein said composition has water absorption at 25° C. for 10 minutes of 0.2 grams per square meter (gsm) at most, when measured by Cobb test.

18. The composition of claim 1, wherein said composition has oil absorption at 180° C. for 20 minutes of 30 gsm at most, when measured by Cobb test.

19. The composition of claim 1, wherein said composition is degradable, compostable, or both.

20. An article being medicament receptacle comprising the composition of claim 1.

21. (canceled)

22. The article of claim 14, characterized by a tensile strength of 15 MPa to 35 MPa.

23. The article of claim 14, having an ultimate elongation of 1.5% to 5%.

24. (canceled)

25. (canceled)

26. A process for conferring water or oil resistance to a composition, comprising mixing:
(i) a first pulp;
(ii) an acrylate or any derivative thereof;
(iii) a fluoropolymer or any derivative thereof; and
(iv) water,
wherein said acrylate or any derivative thereof and said fluoropolymer or any derivative thereof are mixed in said composition in a ratio ranging from 0.5:2 (w/w) to 2:20 (w/w) per 100 gr dry pulp, thereby conferring water or oil resistance to the composition.

27. The process of claim 26, wherein said water is present in said composition in an amount of 0.1-3% by weight, or at least 80% by weight.

28. (canceled)

29. (canceled)

30. (canceled)

31. (canceled)

32. (canceled)

33. (canceled)

34. (canceled)

35. (canceled)

36. (canceled)

37. (canceled)

38. The process of claim 26, wherein said fluoropolymer is present in said composition in an amount of 0.015 to 0.075%, per 100 gr dry pulp.

39. (canceled)

40. (canceled)

41. (canceled)

42. (canceled)

43. (canceled)

44. (canceled)

45. The process of claim 26, wherein said acrylate is present in said composition in an amount of 0.1 to 0.5%, per 100 gr dry pulp.
